(19) United States
(12) Patent Application Publication
(10) Pub. No.: US 2026/0109541 A1
(43) Pub. Date: Apr. 23, 2026

(54) AUTOMATIC STORAGE AND RETRIEVAL SYSTEM HAVING CONTAINER BASED PICKING WORKSTATION

(71) Applicant: Symbotic LLC, Wilmington, MA (US)

(72) Inventor: William J. Fosnight, Windham, NH (US)

(21) Appl. No.: 18/993,465

(22) PCT Filed: Jul. 12, 2023
(86) PCT No.: PCT/US2023/027529

§ 371 Date: Jan. 10, 2025

Related U.S. Application Data
(60) Provisional application No. 63/388,500, filed on Jul. 12, 2022.

(51) Int. Cl. B65G 1/04; B65G 1/137

(52) U.S. Cl. CPC B65G 1/0485; B65G 1/0492; B65G 1/1378; B65G 2203/044

(57) ABSTRACT

An order fulfillment system for fulfilling orders for goods includes a storage structure configured to store totes, mobile robots configured to transport the totes, and a workstation. The workstation includes a first station configured to receive product totes storing the goods for fulfilling the orders and a second station configured to receive order totes storing the goods of fulfilled orders. The order fulfillment system may also include containers configured to receive the goods from the product totes or the order totes. The containers may be stored at a third station of the workstation and/or in an order tote located at the second station of the workstation and/or in at least one shopping cart located at the workstation.

### PRIORITY DATA

The present application claims priority to U.S. Provisional Patent Application No. 63/388,500, filed on Jul. 12, 2022, entitled “AUTOMATIC STORAGE AND RETRIEVAL SYSTEM HAVING CONTAINER BASED PICKING WORKSTATION”, which is incorporated by reference herein in its entirety.

### TECHNICAL FIELD

This disclosure relates generally to automated storage and retrieval systems, and in particular, to automated storage and retrieval systems including container picking workstations.

### BACKGROUND

An order fulfillment system for use in supply chains, for example in retail supply chains, may fulfill orders for individual product units or goods. Conventional systems may transfer totes including inventory using mobile robots between a storage structure and one or more picking workstations where orders are processed by a picker sequentially picking from inventory or product totes to order totes that contain eaches picked making up a given order. The order totes may have one or more containers such as plastic or paper bags, boxes or otherwise where the eaches are put in the container during picking to allow the user to remove containers containing the eaches that make up a given order for transport after fulfillment.

### BRIEF DESCRIPTION OF THE DRAWINGS

Disclosed herein are embodiments of systems and methods relating to automated storage and retrieval of retail products for order fulfillment. This description includes drawings, wherein:

FIG. 1 shows a perspective view of an automated order fulfillment facility including a product storage structure, mobile robots, and workstations according to some embodiments;

FIG. 2 is a schematic side view of a workstation of an automated order fulfillment facility in accordance with some embodiments;

FIG. 3 is a perspective enlarged view of a workstation and portions of a product storage structure of an automated order fulfillment facility according to some embodiments;

FIG. 4 is a top view of the workstation and portions of a product storage structure of the automated order fulfillment facility of FIG. 3;

FIG. 5 is a top view of a workstation of an automated order fulfillment facility in accordance with some embodiments;

FIG. 6 is a flow chart illustrating exemplary steps of associated with product retrieval at an automated order fulfillment facility according to some embodiments;

FIG. 7 is a flow chart illustrating exemplary steps associated with product retrieval at an automated order fulfillment facility according to some embodiments;

FIG. 8 is a flow chart illustrating exemplary steps associated with product retrieval at an automated order fulfillment facility according to some embodiments;

FIG. 9 is a perspective view of a workstation of an automated order fulfillment facility according to some embodiments;

FIG. 10 is a top view of the workstation of the automated order fulfillment facility of FIG. 10;

FIG. 11 is a perspective view of a workstation of an automated order fulfillment facility according to some embodiments;

FIG. 12 is a top view of the workstation of the automated order fulfillment facility of FIG. 11; and

FIG. 13 is a flow chart illustrating exemplary steps of associated with product retrieval at an automated order fulfillment facility according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but understood elements that are useful or necessary in a commercially feasible embodiment are often not depicted in order to facilitate a less obstructed view of these embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the art as set forth above except where different specific meanings have otherwise been set forth herein.

### DETAILED DESCRIPTION

Embodiments of the present technology will now be described with reference to the figures, which in general relate to an automatic storage and retrieval system having a container based picking workstation. The embodiments described enable a higher level of packing density of orders, for example, by allowing an operator to fill containers to capacity as opposed to relying on the machine being conservative in terms of container capacity. Further and as will be described, the embodiments are intended to enable more efficient use of resources as bagging is done at the workstation as opposed to offline bagging of totes.

It is understood that the present embodiments may be embodied in many different forms and should not be construed as being limited to the embodiments set forth herein. Rather, these embodiments are provided so that this disclosure will be thorough and complete and will fully convey the invention to those skilled in the art. Indeed, the embodiments are intended to cover alternatives, modifications and equivalents of these embodiments, which are included within the scope and spirit of the invention as defined by the appended claims. Furthermore, in the following detailed description, specific details are set forth in order to provide an understanding of the present embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

The terms “top” and “bottom,” “upper” and “lower” and “vertical” and “horizontal” as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application. In one non-limiting embodiment, the acceptable manufacturing tolerance is ±0.25%.

For purposes of this disclosure, a connection may be a direct connection or an indirect connection (e.g., via one or more other parts). In some cases, when a first element is referred to as being connected, affixed or coupled to a second element, the first and second elements may be directly connected, affixed or coupled to each other or indirectly connected, affixed or coupled to each other. When a first element is referred to as being directly connected, affixed or coupled to a second element, then there are no intervening elements between the first and second elements (other than possibly an adhesive or weld used to connect, affix or couple the first and second elements).

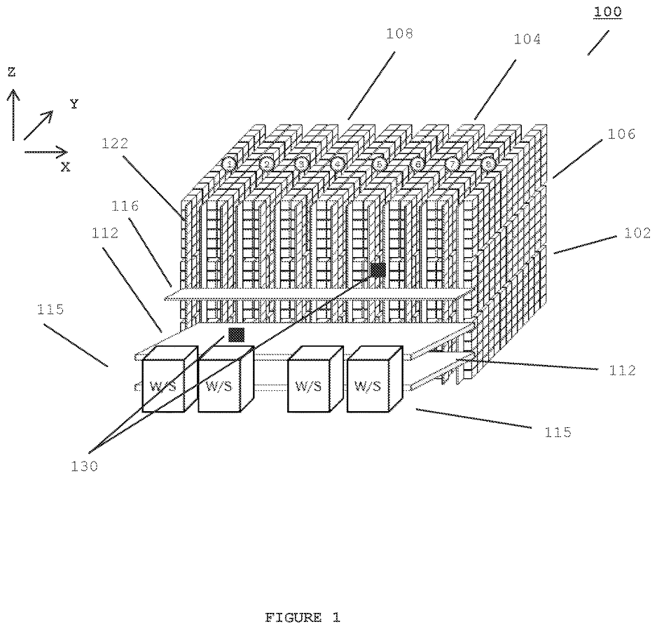

FIG. 1 shows a perspective view of an order fulfillment facility 100 showing a storage structure 102 including a number of bays 104 of storage locations 106 according to some embodiments. The bays 104 each include a y-z array of storage locations 106 in horizontal rows and level changing towers along the rows which in embodiments may be vertical towers. Mobile robots 130 may travel between storage levels in the z-direction within the level changing towers in the y-direction. The pairs of bays 104 are arranged to face each other, separated by aisles 108. An aisle 108 may have a width such that a mobile robot 130 traveling within an aisle 108 may transfer containers to the bays 104 on either side of the aisle 108.

The order fulfillment facility 100 includes decks 112 spaced apart at different vertical levels of the storage structure 102. The decks 112 may be arranged in pairs and extend between the aisles so that robots 130 can maneuver in the x-y plane of each deck to travel between different aisles. One of the decks 112 or suitable supporting structure may also extend into the respective aisles to allow technicians to walk into an aisle 108 to service components within the aisle. The order fulfillment facility 100 also includes an express deck 116 arranged to extend between the aisles so that robots 130 can maneuver in the x-y plane to travel between different aisles. Decks 112 may be provided for transit of the mobile robots 130 between aisles or for transit of the mobile robots 130 between aisles and workstations (such as workstations 115). Here, Express deck(s) 116 may be provided for x-direction movement, transit deck(s) 112 may be provided for the mobile robots 130 to enter and return from the workstation 115 and transit deck(s) 112 may also provide transit between the workstations 115 and storage structure 102. Each workstation 115 is equipped to receive pairs of one or more mobile robots as will be described. For example, a first mobile robot at a station may carry a product tote, in combination with successive mobile robots with items for fulfilling product requests to make up an order. A second mobile robot at the station may carry an order tote, in combination with successive mobile robots as required, within which containers of items from the product totes are placed to fulfill product requests to make up an order having one or more order totes. The containers may be bags such as plastic or paper bags. In alternate aspects, containers may be cardboard or any suitable material. Workers at a workstation manually transfer items from a product tote to a container and ultimately to the order tote under guidance of an inventory control system at the workstation.

As noted above, the order fulfillment facility 100 may further include a number of mobile robots 130 for transferring totes or other product or order containers to and from workstations 115 and storage locations 106 in the bays 104. The mobile robots 130 may be self-guided and/or rail-guided so as to move horizontally and vertically within aisles 108 to transfer totes or other product containers between the mobile robots 130 and storage locations 106. For example, a track system including horizontal rails may be affixed to the bays 104 at different vertical levels. The horizontal rails provide access to storage shelves on either side of an aisle 108 in the x-direction on a given level. The bays 104 include vertical level changing towers 122 within which the mobile robots may travel vertically in the z-direction between levels of storage locations 106.

Further details of the workstations, storage structure and mobile robot which may be used are described for example in the following U.S. patents and patent applications: U.S. Pat. No. 9,139,363, to John Lert, entitled “Automated System For Transporting Payloads,” issued Sep. 22, 2015; U.S. Pat. No. 10,435,241, to John Lert and William Fosnight, entitled, “Storage and Retrieval System,” issued Oct. 8, 2019; and U.S. Pat. No. 11,142,398, to John Lert and William Fosnight, entitled, “Order Fulfillment System,” issued Oct. 12, 2021. Each of these patents and applications are incorporated by reference herein in their entirety. Although order fulfillment facility 100 has been described with respect to autonomous mobile robots having the ability to transport totes from storage to decks to workstations and back, the workstation embodiment and disclosure regarding the operation of the workstation is not limited by the automation configuration described.

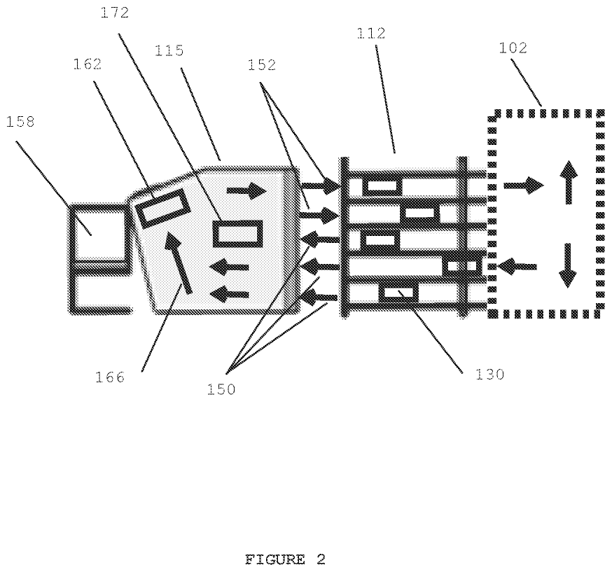

FIG. 2 is a side view of an exemplary workstation 115 in an order fulfillment facility 100 in accordance with aspects of the disclosed embodiment. Workstations 115 are shown connected to decks 112 which are in turn connected to storage structure 102. By arranging the workstation as shown, 2 or more input levels 150 or output levels 152 may be provided for the mobile robots 130 to access and depart workstation 115 as opposed to 1 input/1 output. Alternately any suitable combination may be provided, for example, 2 input levels and 1 output level or otherwise. Workstation 115 has operator platform 158 where an operator can access a tote at picking location 162 where a tote may be presented by an autonomous mobile robot 130 or otherwise. Picking location 162 forms an opening where the operator can reach into the tote that is presented to pick inventory from a product tote and/or place picked inventory into an order tote. In the embodiment shown, mobile robots 130 with totes may enter workstation 115 at any of 3 lower levels and climb 166 to location 162. Mobile robots 130 exit the workstation at the top level but may alternately traverse to a lower level and then depart workstation 115. The mobile robots 130 may stop prior to climbing, for example, where the mobile robot 130 is acting as (or stored in) a buffer location 172. The mobile robots 130 may sequentially bring product totes containing inventory to be picked to make up an order that is placed in order tote(s).

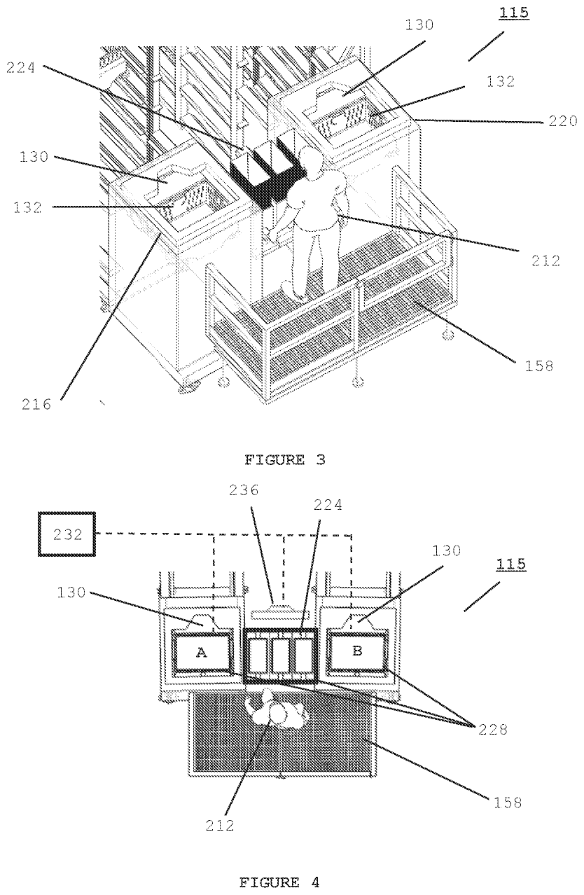

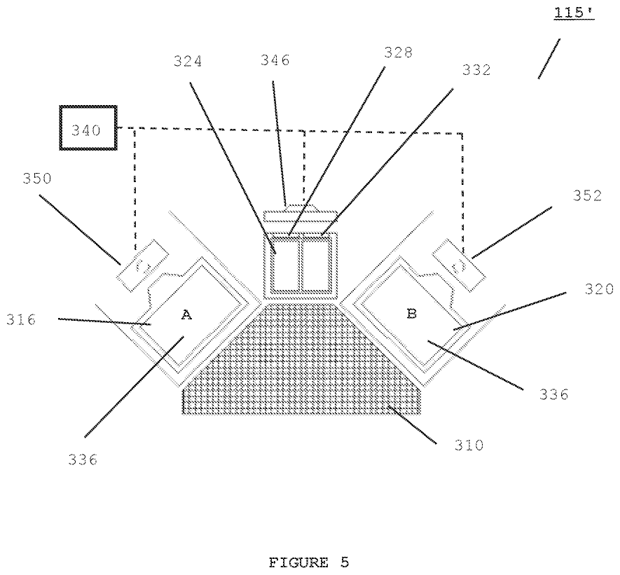

FIG. 3 is an isometric view of workstation 115. FIG. 4 is a top view of workstation 115. Workstation 115 has operator platform 158 from which operator 212 may access an A side picking location or station 216, a B side picking location or station 220 and a bagging location or station 224. A sensor 228 may be provided to sense an X-Y location and area of an object breaking the plane above the totes and/or containers. The measuring array sensor and other features of the workstation may be provided as disclosed in U.S. Pat. No. 10,984,375 issued on Apr. 20, 2021 and entitled “Picking Workstation With Mobile Robots & Machine Vision Verification of Each Transfers Performed by Human Operators” hereby incorporated by reference in its entirety. Sensor 228 may be used to verify that objects picked or placed have been extracted from or inserted to a correct area in a given location. Sensors 228 may also be utilized as a safety measure such that an obstruction or hand may be detected or not detected above the plane of the tote such that the mobile robot 130 may safely arrive or depart with no obstruction detected.

In the embodiment of workstation 115 shown in FIGS. 3 & 4, bagging station 224 is shown having stacks of nested light cardboard containers where the stack may be spring loaded to keep the top surfaces of the containers at an ergonomic level. The spring loading may be unidirectional up such that the ergonomic level of the container stays constant as the containers are loaded with eaches of inventory to form an order. “Springs” or a spring loading may be replaced with an active indexer or passive ratcheting indexer “indexing” as the way to lift the light cardboard boxes or bags or suitable container to the ergonomic height. Bagging station 224 is shown having 3 stacks of containers but in alternate embodiments more or less may be provided. Mobile robots 130 having totes 132 are shown in picking or placing positions A&B (216, 220).

Controller 232 is operably connected to GUI 236 and sensors 228 where controller 232 may act as a supervisory controller dispatching and releasing mobile robots 130 bots and totes 132. Controller 232 is also operably coupled to video projectors (not shown) that highlight where operator 212 should pick from and/or place to. The bag station 224 (2 or 3) is shown located between mobile robot presentation locations 216, 220 in workstation 115. Bag station 224 may optionally include an automated bag opener (not shown) which may comprise air blowers which blow air down into the bags to open the bags. The automated bag opener may be configured differently in further embodiments. One such further embodiment may include sets of fingers, tines or other features which grip/engage edges of the bags at the station 224 and move oppositely of each other to ensure the bags are open at station 224 and ready to receive inventory.

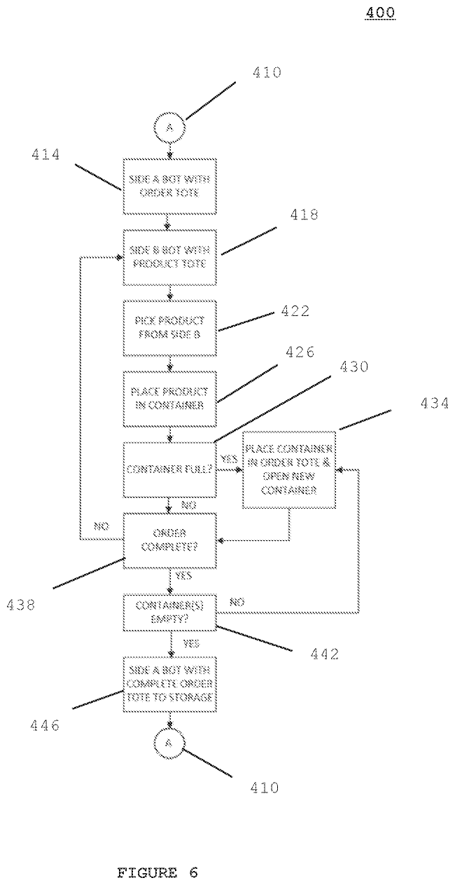

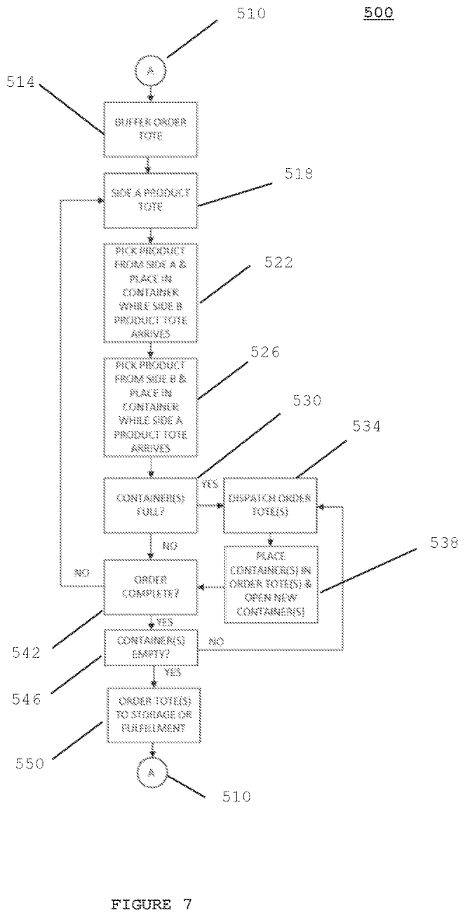

Exemplary sequences of operation will be described with respect to FIGS. 6 and 7 but operationally controller 232 provides a sequence whereby the totes are sequenced and uses the projectors in a pick/put operation to light the proper sequence from Product Tote(s) at 216 and/or 220 locations to a bag at location 224 (based on product compatibility). In alternate aspects, the relative tote locations and bagger locations may be modified. In operation, picker 212 may be free to keep adding eaches to bag(s) at station 224 until they deem a bag is full. The picker 212 may then remove and ‘drop’ the bag or container into an Order Tote as will be described. Controller 232 also tracks the aggregate weight of the eaches deposited into container(s) and ultimately into a tote to ensure picker 212 is not able to put more than a threshold capacity, for example, >50 lbs in an Order Tote. The following features of the disclosed embodiment may apply:
1. Reduce per bag labor from 15-20 sec (hook) to 3-5 sec lift and set
2. Higher packing density than a bag packing algorithm
3. Elimination of 2 Mobile Robot Cycles per Order Tote (no more retrieval for bagging and return to storage)
4. Picking speed offset by time required to place bags in totes.

FIG. 5 is a top view of an alternate embodiment workstation 115′. Workstation 115′ has features similar to workstation 115 but with the tote locations angled relative to each other. Workstation 115′ has operator platform 310 from which an operator may access an A side picking location or station 316, a B side picking location or station 320 and a bagging location or station 324.

A measuring array sensor may be provided to sense an X-Y location and area of an object breaking the plane above the totes and/or containers where the sensor may be used to verify that objects picked or placed have been extracted from or inserted to a correct area in a given location. The sensors may also be utilized as a safety measure such that an obstruction or hand may be detected or not detected above the plane of the tote such that the mobile robot 130 may safely arrive or depart with no obstruction detected.

Bagging station 324 is shown utilizing a pair of wicketed e-commerce bags opened by airblower bag openers (not shown) for bags on wickets 328, 332. Bagging station 224 is shown having 2 wicketed e-commerce bags but in alternate embodiments more or less may be provided. Totes 336 are shown in picking or placing positions A&B 316, 320. Controller 340 is operably connected to GUI 346 and the measuring array sensors where controller 340 may act as a supervisory controller dispatching and releasing mobile robots 130 and totes 132. Controller 340 is also operably coupled to video projectors 350, 352 (not shown at station 324) that highlight where the operator should pick from and/or place to. The video projectors 350, 352 may be referred to herein as a vision verification system.

Exemplary sequences of operation will be described with respect to FIGS. 6 and 7 but operationally controller 240 provides a sequence whereby the totes are sequenced and uses the projectors in a pick/put operation to light the proper sequence from Product Tote(s) at 316 and/or 320 locations to a bag at location 324 (based on product compatibility). In alternate aspects, the relative tote locations and bagger locations may be switched or otherwise modified. In operation, the picker may be free to keep adding eaches to bag(s) at station 324 until they deem a bag is full where then the picker removes and ‘drop’ the bag or container into an Order Tote as will be described. Controller 340 also tracks the aggregate weight of the eaches deposited container(s) and ultimately into a tote to ensure the picker is not able to put more than a threshold capacity, for example, >50 lbs in an Order Tote.

FIG. 6 is a process flow diagram for process 400 whereby eaches are sequentially picked from side B, placed in bags and compiled into an order tote at side A of the picking workstation. The sequence begins at “A” 410 where a product tote is presented at side B 418. The picker picks 422 product from side B and places the product picked into the bag or container 426. If the container is full 430 the picker places the container in the order tote (at side A) and opens a new container 434; if the order is then not complete 438 then another tote is presented at side B 418 and the picking continues.

If the container is not full 430 and if the order is then not complete 438 then another tote is presented at side B 418 and the picking continues. If on the other hand the order is then complete 438, there is a check for containers that have not been put in the order tote 442. If there are partially filled (not empty) containers 442 then the partially filled container is placed in the order tote 434. If all of the remaining containers are empty 442 then the order tote is returned to storage 446. At this point the next order tote is dispatched to side “A” and the picking process continues 410.

FIG. 7 is a process flow diagram for process 500 whereby eaches are sequentially picked from both sides A and B, placed in bags and compiled into an order tote that is buffered locally at the picking workstation and dispatched when a bag or bags needs to be placed in the order tote. The sequence begins at “A” 510 where an order tote is buffered locally 514. A product tote is presented at side A 518. The picker picks 522 product from side A and places the product picked into the bag or container 522 while in parallel a product tote is presented at side B. The picker picks 522 product from side B and places the product picked into the bag or container 526 while in parallel a product tote is presented at side A. If the container is full 530 then the order tote is dispatched (to side A or B) 534 and the picker places the container in the order tote 538 and opens a new container; if the order is then not complete 542 then another tote is presented at side A 518 and the picking continues.

If the container is not full 530 and if the order is then not complete 542 then another tote is presented at side A 518 and the picking continues. If on the other hand the order is then complete 542, there is a check for containers that have not been put in the order tote 546. If there are partially filled (not empty) containers 546 then an order tote is dispatched 534 and the partially filled container is placed in the order tote 538. If all of the remaining containers are empty 546 then the order tote is returned to storage 550. At this point the next order tote is dispatched to a buffer location 514 and the picking process continues 510.

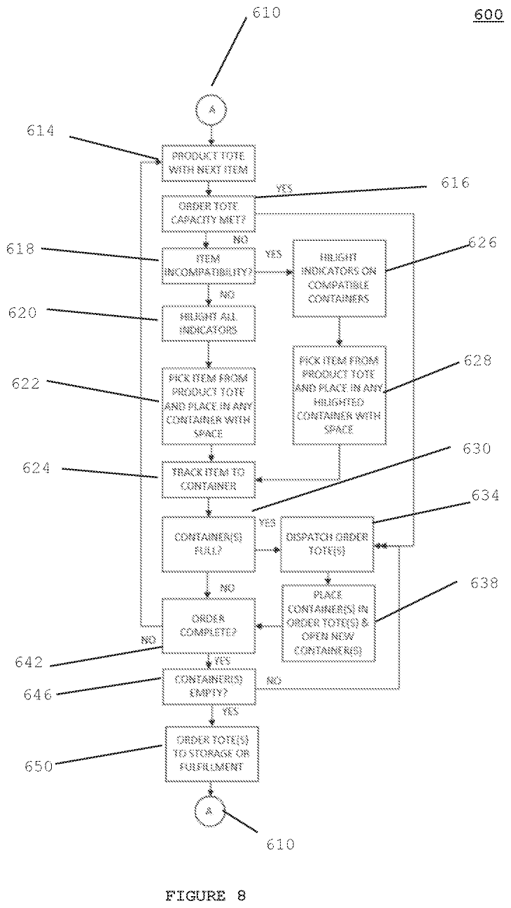

FIG. 8 is a process flow diagram for process 600 whereby eaches may be sequentially picked from both sides A and B as in FIG. 7 or alternately from a single side as in FIG. 6, placed in bags and compiled into an order tote that is buffered locally at the picking workstation and dispatched when a bag or bags needs to be placed in the order tote as in FIG. 7 or alternately buffered on the order tote side of the workstation as in FIG. 6. The sequence begins at “A” 610 where an order tote is buffered locally and the next item for the order 614 is identified. The next item is checked in the event adding it to the order will put the order tote over a predetermined capacity, for example 50 lbs. or more.

If the order tote capacity is exceeded 616 an order tote is dispatched 634 to be filled to capacity with the container(s). If the order tote capacity is not met 616 the item to be picked is checked for compatibility with the items that already have been placed in container(s). Here, the picker is directed to place compatible product types into specific bags containers. For example, the projector, LED indicator lights (at each container) or otherwise direct the picker to where bags of compatible eaches are contained (for example, so as to not put hazardous items in the same bag as baby food). If there is no compatibility issue then all of the placing container(s) are highlighted 620 and the item is picked from the product tote and placed in any container with space 622. The item is tracked as to which container it was placed 624.

If there a compatibility issue then each of the placing container(s) are highlighted that are compatible with the to be picked each 620 and the item is picked from the product tote and placed in any compatible container with space 628. The item is tracked as to which container it was placed 624. If there compatibility issues with all of the containers, then an order tote is dispatched to offload one or more in the incompatible container(s) so fresh compatible containers can be provided. If the container is full 630 then the order tote is dispatched (to side A or B if not already there) 634 and the picker places the container in the order tote 638 and opens a new container; if the order is then not complete 642 then another tote is presented 614 and the picking continues.

If the container is not full 630 and if the order is then not complete 642 then another tote is presented 614 and the picking continues. If on the other hand the order is then complete 642, there is a check for containers that have not been put in the order tote 646. If there are partially filled (not empty) containers 646 then an order tote is dispatched if not already there 634 and the partially filled container is placed in the order tote 638. If all of the remaining containers are empty 646 then the order tote is returned to storage 650. At this point the next order tote is dispatched to a buffer location or the workstation and a product tote identified 614 and the picking process continues 610.

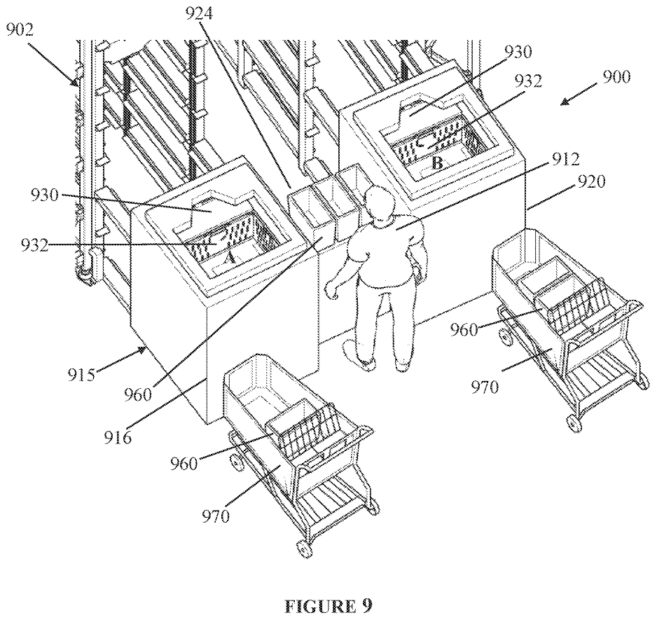

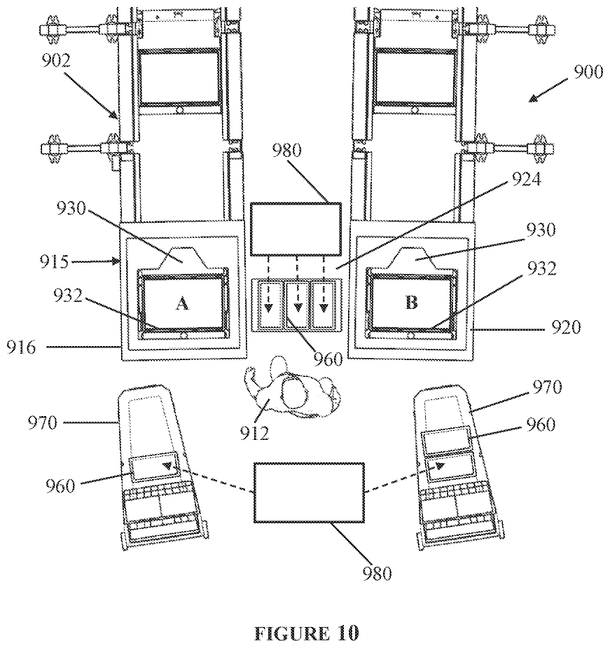

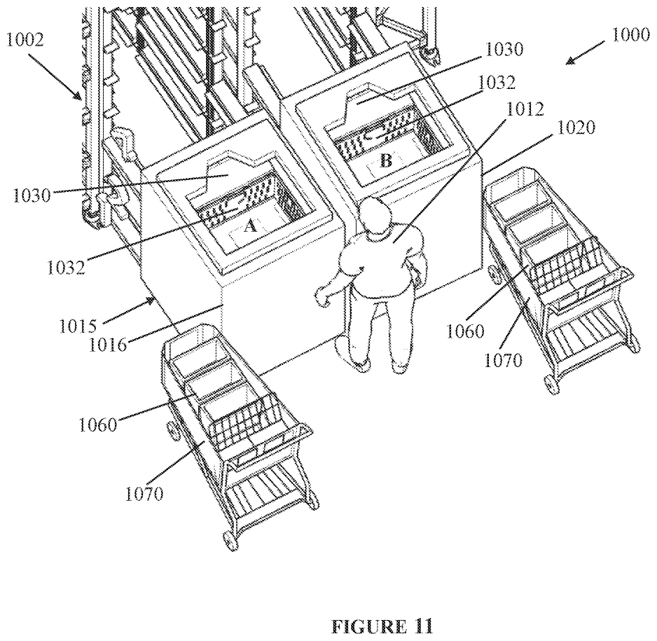

FIG. 9 shows a perspective view of a workstation 915 of an automated order fulfillment facility 900 including a product storage structure 902 and mobile robots 930 according to some embodiments. FIG. 10 shows a top view of the workstation 915 of FIG. 9. The exemplary workstation 915, (which may be workstation, where products/goods are picked from totes and placed into other totes and/or containers 960 and/or at least one shopping cart 970, for example), permits an operator 912 to access an A side picking location or station 916, a B side picking location or station 920 and a bagging location or station 924. In some embodiments, instead of a human operator 912 picking and placing the products/goods at the workstation 915, the workstation 915 may have a robot with one or more robotic arms for picking and placing the products/goods such as disclosed, for example, in U.S. patent application Ser. No. 17/338,814, filed June 4, 2021 and entitled “Robotic Each Picking in a Micro-Fulfillment Center,” which is hereby incorporated by reference in its entirety. As used herein, a product or products that may be ordered by consumers may be referred to as “a good” or “goods”, an individual product or good may be referred to as an “each”, and individual ones of the products or goods may be referred to as “eaches”.

In the workstation 915 according to the exemplary embodiment shown in FIGS. 9 and 10, the bagging location or bagging station 924 is shown as having three side-by-side stacks of cardboard containers 960 (although it will be appreciated that more or less stacks of the containers 960 may be located at the bagging location 924 of the workstation 915). Notably, while FIGS. 9 and 10 show the cardboard containers 960 in the bagging location 924, it will be appreciated that the containers 960 do not have to be made of cardboard and may be made of any other suitable material such as plastic and may have a variety of sizes and shapes. In addition, the bagging location 924 may store containers that are bags (e.g., plastic bags, paper bags, cloth bags, single use bags, multi-use bags, etc.) instead of or in combination with the containers 960. It should be also noted that, as mentioned above, the stack of containers 960 located in the bagging location 924 may be spring-loaded to keep the top surfaces of the containers 960 at an ergonomic level.

As mentioned above, in some embodiments, one or more sensors may be provided to sense an X-Y location and area of an object breaking the plane above the totes 932 and/or the containers 960. For example, one or more sensors may be used to verify that the objects (e.g., customer-ordered products or goods) picked from a product tote (or order tote) 932 or placed into a product tote (or order tote) 932 have been extracted from or inserted to a correct area in a given location. In addition, the sensor(s) may also be utilized as a safety measure such that an obstruction or hand may be detected or not detected above the plane of a given tote 932 such that the mobile robot(s) 930 may safely arrive at the workstation 915 or depart from the workstation 915 with no obstruction detected.

In addition, as mentioned above, the workstation 915 may include video projectors (not shown) that highlight which totes 932 the operator 912 should pick products from and/or which totes 932 and/or containers 960 the operator 912 should place products into. The workstation 915 may also be coupled to a controller (not shown) that may be operably coupled to the video projectors and that may act as a supervisory controller dispatching and releasing the mobile robots 930 and the product totes (and/or order totes) 932.

In the embodiment illustrated in FIG. 9, mobile robots 930 having totes 932 are shown in picking or placing positions A and B (916 and 920, respectively) of the workstation 915, and the bagging location 924 of the workstation 915 is shown located between the mobile robot tote presentation locations A and B (916, 920) of workstation 915. In some embodiments, the stacks of containers 960 may be automatically pre-loaded into the bagging location 924 and/or into the totes 932 at the picking and/or placing positions A and B (916, 920) via an optional container dispenser 980 (shown by way of example in FIG. 10 with dashed line arrows indicating the placement of the containers 960 into their respective locations at the bagging station 924 and in the shopping carts 970), for example, such as those disclosed in U.S. patent application Ser. No. 17/884,345, filed Aug. 9, 2022 and entitled “Container to Tote Dispense Integrated With Automated Storage and Retrieval System,” which is hereby incorporated by reference in its entirety.

As mentioned above, in some embodiments, a controller (not shown) provides a sequence whereby the product/order totes 932 are sequenced into their respective picking/placement areas A and B (916, 920), and uses the projectors in a pick/put operation to light the proper sequence of picking from product tote(s) 932 at location A 916 and/or location B 920 to a container 960 at the bagging station 924 (based on product compatibility). In some implementations, the operator 912 of the workstation 915 may be free to arbitrarily pick caches from the product tote(s) 932 and/or to keep adding caches to the container(s) 960 at the bagging station 924 until the operator 912 deems the container(s) 960 to be full. The operator 912 may then remove and ‘drop’ the container(s) 960 into an order tote 932 (which may be located in position A 916 or position B 920), or into a shopping cart 970 as will be described below.

In one exemplary embodiment of operation of the workstation 915, eaches (i.e., individual products) are sequentially picked by the operator 912 from product tote(s) 932 on either or both picking/placement areas A and B (916, 920), after which the picked eaches are placed by the worker 912 into one or more containers 960 that are located at the bagging location 924 of the workstation 915. Then, the operator 912 may move the containers or bags 960 filled according to the pending orders being fulfilled directly into one or more shopping carts 970 located at the workstation 915. Then, the shopping carts 970 containing the containers 960 may be moved by the operator 912 or another worker (or guided via a remote control) to an order pickup area, where a customer may pick up the shopping cart or where a worker may remove one or more container(s) 960 from the shopping cart(s) 970 and hand over the customer-ordered product(s) to the customer. It is noted that while shopping carts 970 are illustrated in a conventional way, shopping carts may be any movable (e.g., wheeled or carried) cart, container, flatbed, etc.

In some embodiments, after the operator 912 picks the eaches from the product totes 932 on either or both location A 916 and/or location B 920 of the workstation 915, instead of placing the picked eaches into the containers 960 located at the bagging location 924 of the workstation 915, the operator 912 may place the picked eaches into containers 960 that are preloaded into one or more shopping carts 970 located at the workstation 915. Notably, in some embodiments, the containers 960 located in the shopping carts 970 may be automatically pre-loaded into the shopping carts 970 via a container dispenser 980, such as disclosed in U.S. patent application Ser. No. 17/884,345, filed Aug. 9, 2022 and entitled “Container to Tote Dispense Integrated With Automated Storage and Retrieval System,” incorporated by reference herein in its entirety.

In some embodiments, when the operator 912 picks all products that completely fulfill a given order and packs these products into one or more containers 960 located at the bagging station 924, but there is no reason to place the packed containers 960 into the shopping carts 970 because it is known that the customer will not be picking up the customer's order until a later time (e.g., when placing the order, the customer specified an order pickup time that is much later than the picking operation), after the operator 912 picks the eaches from the product totes 932 at either or both location A 916 and/or location B 920, instead of placing the product-filled containers 960 located at the bagging station 924 into a shopping cart 970, the operator 912 may place the containers 960 into an order tote 932 that is presented by a mobile robot 930 either at side A 916 or side B 920 of the workstation 915, after which the order tote 932 is returned to the storage structure 902 to be retrieved at a later time. In some embodiments, the operator 912 interacts with a user interface to request that the order tote 932 be brought to the workstation by a mobile robot.

At the later time, i.e., when the order is ready to be dispensed because it is known that the customer will pick up the order soon, the order tote 932 with the containers 960 storing the products ordered by the customer may be returned by a mobile robot 930 from the storage structure 902 back to either side A 916 or side B 920 of the workstation 915, and the operator 912 may then move the containers 960, which contain the products associated with the pending orders being fulfilled, from the order tote 932 directly into the shopping carts 970 located at the workstation 915. Then, the shopping carts 970 with the container(s) 960 that contain the products associated with the order being picked up by the customer may be moved by the operator 912 or another worker (or guided via a remote control) to an order pickup area, where a customer may pick up the shopping cart or (may add same comment elsewhere) where a worker may remove the container(s) 960 from the shopping cart(s) 970 and hand over the customer-ordered products to the customer.

In some embodiments, when the operator 912 picks all products that completely fulfill a given order, but it is known that the customer will not be picking up the customer's order until a later time (e.g., when placing the order, the customer specified an order pickup time that is significantly after the product-picking operation), after the operator 912 picks the eaches from the product totes 932 on either or both picking/placement areas A and B (916, 920), instead of placing the picked eaches into the containers 960 located at the bagging station 924, the operator 912 may place the picked caches into an order tote 932 that is presented by a mobile robot 930 either at side A 916 or side B 920 of the workstation 915, after which the order tote 932 containing the picked eaches (which are not stored in containers 960 but are stored directly in the order tote 932) is returned to the storage structure 902 to be retrieved at a later time. In some embodiments, the operator 912 interacts with a user interface to request that the order tote 932 be brought to the workstation by a mobile robot.

At the later time, i.e., when the order is ready to be dispensed because it is known that the customer will pick up the order soon, the order tote 932 storing the products ordered by the customer may be returned by a mobile robot 930 from the storage structure 902 back to either side A 916 or side B 920 of the workstation 915, and the operator 912 may then move the products associated with the pending orders being fulfilled from the order tote 932 directly into containers 960 that are preloaded into one or more shopping carts 970 located at the workstation 915. Notably, the products that make up an order of a customer are not necessarily picked from one order tote 932 delivered by a mobile robot 930 to side A 916 or side B 920 of the product storage structure 902, since some products of the order may be room temperature items (which would be stored/transported within the product storage structure 902 in ambient order totes 932), some products of the order may be refrigerated items (which would be stored/transported within the product storage structure 902 in chilled order totes 932), and some products of the order may be frozen items (which would be stored/transported within the product storage structure 902 in frozen order totes 932). In addition, the products associated with an order of a customer are not necessarily packed from the one or more order totes 932 at side A 916 or side B 920 of the workstation 915 into one container 960 located in a shopping cart 970, since the order may include a number of products that simply do not fit into one container 960 and may require two or more containers 960 to fit all of the products ordered by the customer in a single order.

As mentioned above, in some embodiments, the containers 960 located in the shopping carts 970 may be automatically pre-loaded into the shopping carts 970 via a container dispenser 980 (see FIG. 10), such as disclosed in U.S. patent application Ser. No. 17/884,345, filed Aug. 9, 2022 and entitled “Container to Tote Dispense Integrated With Automated Storage and Retrieval System,” incorporated by reference herein in its entirety. Then, the shopping carts 970 with the container(s) 960 with the products associated with the order being picked up by the customer may be moved by the operator 912 or another worker (or guided via a remote control) to an order pickup area, where a worker may remove the container(s) 960 from the shopping cart(s) 970 and hand over the customer-ordered products to the customer.

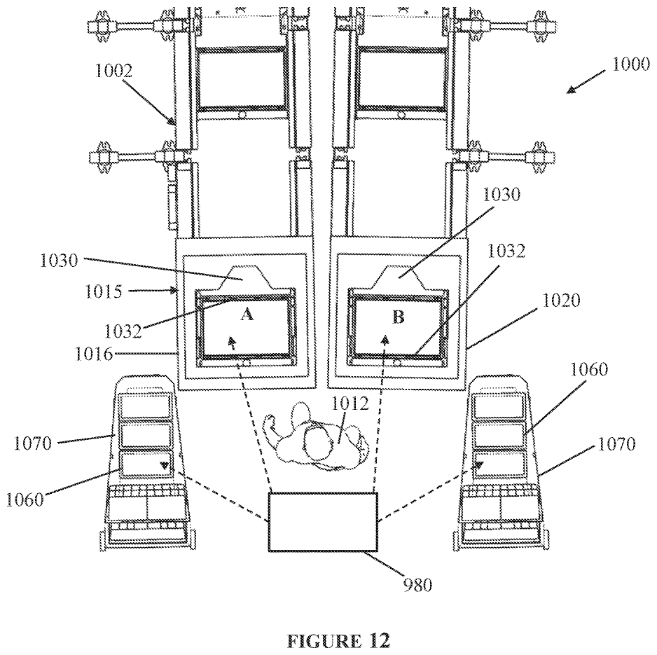

FIG. 11 shows a perspective view of a workstation 1015 of an automated order fulfillment facility 1000 including a product storage structure 1002 and mobile robots 1030 according to some embodiments. FIG. 12 shows a top view of the workstation 1015 of FIG. 11. The exemplary workstation 1015 permits an operator 1012 to access an A side picking location or station 1016 or a B side picking location or station 1020. Notably, unlike the exemplary workstation 915 shown in FIGS. 9 and 10, the exemplary workstation 1015 shown in FIGS. 11-12 does not include a bagging location or station (akin to the bagging location or station 924) between the picking location A 1016 and the picking location 1020. Instead, as will be described in more details below, the containers 1070 into which the products picked from the picking location A 1016 and/or picking location B 1020 are placed are located in (and are preferably automatically pre-filled into) one or more shopping carts 1070 that are located at the working station 1015.

As mentioned above, in some embodiments, one or more sensors may be provided to sense an X-Y location and area of an object breaking the plane above the totes 1032 located at the picking/placing location A 1016 and/or the picking/placing location B 1020. For example, one or more sensors may be used to verify that the objects (e.g., customer-ordered products) picked from a product tote (or order tote) 1032 or placed into a product tote (or order tote) 1032 have been extracted from or inserted to a correct area in a given location. In addition, the sensor(s) may also be utilized as a safety measure such that an obstruction or hand may be detected or not detected above the plane of a given tote 1032 such that the mobile robot(s) 1030 may safely arrive at the workstation 1015 or depart from the workstation 1015 with no obstruction detected.

In addition, as mentioned above, the workstation 1015 may include video projectors (not shown) that highlight which totes 1032 the operator 1012 should pick products from and/or which totes 1032 and/or containers 1060 (located in the shopping carts 1070) the operator 1012 should place products into. The workstation 1015 may also be coupled to a controller (not shown) that may be operably coupled to the video projectors and that may act as a supervisory controller dispatching and releasing the mobile robots 1030 and the product totes (and/or order totes) 1032.

In the embodiment illustrated in FIG. 11 mobile robots 1030 having totes 1032 are shown in picking or placing positions A and B (1016 and 1020, respectively) of the workstation 1015, while the containers 1060 into which the products picked from the totes 1032 may be placed are shown as being located directly within the shopping cart(s) 1070. As mentioned above, in some embodiments, the stacks of the containers 1060 may be automatically pre-loaded into the shopping carts 1070 via an optional container dispenser 1080 (shown by way of example in FIG. 12 with dashed line arrows indicating the placement of the containers 1060 into their respective locations in the shopping carts 1070 and in a tote 1032), such as disclosed in U.S. patent application Ser. No. 17/884,345, filed Aug. 9, 2022 and entitled “Container to Tote Dispense Integrated With Automated Storage and Retrieval System,” which is hereby incorporated by reference in its entirety.

As mentioned above, in some embodiments, a controller (not shown) provides a sequence whereby the product/order totes 1032 are sequenced into their respective picking/placement areas A and B (1016, 1020), and uses the projectors in a pick/put operation to light the proper sequence of picking from product tote(s) 1032 at location A 1016 and/or location B 1020 to a container 1060 located in a shopping cart 1070 (based on product compatibility). In some implementations, the operator 1012 of the workstation 915 may be free to arbitrarily pick eaches from the product tote(s) 1032 and/or to keep adding caches to the container(s) 1060 in the shopping cart(s) 1070 until the operator 1012 deems the container(s) 1060 to be full.

In one exemplary embodiment of operation of the workstation 1015, eaches (i.e., individual products) are sequentially picked by the operator 1012 from product tote(s) 1032 on either or both picking/placement areas A and B (1016 and 1020), after which the picked eaches are placed by the worker 1012 into one or more containers 1060 that are located in one or more shopping carts 1070 located at the workstation 1015. Then, the shopping carts 1070 containing the containers 1060 may be moved by the operator 1012 or another worker (or guided via a remote control) to an order pickup area, where a worker may remove one or more container(s) 1060 from the shopping cart(s) 1070 and hand over the customer-ordered product(s) to the customer.

In some embodiments, when the operator 1012 picks all products that completely fulfill a given order, but there is no reason to place the picked products into the containers 1060 located in the shopping carts 1070 because it is known that the customer will not be picking up the customer's order until a later time (e.g., when placing the order, the customer specified an order pickup time that is much later than the picking operation), after the operator 1012 picks the eaches from the product totes 1032 on either or both picking/placement areas A and B (1016 and 1020), instead of placing the picked products into the containers 1060 located in the shopping carts 1070, the operator 1012 may place the picked products into containers 1060 located in an order tote 1032 that is presented by a mobile robot 1030 either at side A 1016 or side B 1020 of the workstation 1015, after which the order tote 1032 is returned to the storage structure 1002 to be retrieved at a later time. In some embodiments, the containers 1060 may be automatically pre-loaded into the order tote 1032 via a container dispenser 1080, such as disclosed in U.S. patent application Ser. No. 17/884,345, filed Aug. 9, 2022 and entitled “Container to Tote Dispense Integrated With Automated Storage and Retrieval System,” which is hereby incorporated by reference in its entirety.

At the later time, i.e., when the order is ready to be dispensed because it is known that the customer will pick up the order soon, the order tote 1032 with the containers 960 storing the products ordered by the customer may be returned by a mobile robot 1030 from the storage structure 1002 back to either side A 1016 or side B 1020 of the workstation 1015, and the operator 1012 may then move the containers 1060, which contain the products associated with the pending orders being fulfilled, from the order tote 1032 directly into the shopping carts 1070 located at the workstation 1015. Then, the shopping carts 1070 with the container(s) 1060 that contain the products associated with the order being picked up by the customer may be moved by the operator 1012 or another worker (or guided via a remote control) to an order pickup area, where a worker may remove the container(s) 1060 from the shopping cart(s) 1070 and hand over the customer-ordered products to the customer.

In some embodiments, when the operator 1012 picks all products that completely fulfill a given order, but it is known that the customer will not be picking up the customer's order until a later time (e.g., when placing the order, the customer specified an order pickup time that is significantly after the product-picking operation), after the operator 1012 picks the eaches from the product totes 1032 on either or both picking/placement areas A and B (1016 and 1020), instead of placing the picked eaches into the containers 1060 located in the shopping carts 1070 or containers 1060 located in an order tote 1032 presented either at side A 1016 or side B 1020 of the workstation 1015, the operator 1012 may place the picked caches directly into an order tote 1032 (i.e., not into containers 1060 located in the order tote 1032) that is presented by a mobile robot 1030 either at side A 1016 or side B 1020 of the workstation 1015, after which the order tote 1032 containing the picked eaches (which are not stored in containers 1060, but are stored directly in the order tote 1032) is returned to the storage structure 1002 to be retrieved at a later time.

At the later time, i.e., when the order is ready to be dispensed because it is known that the customer will pick up the order soon, the order tote 1032 that stores the products ordered by the customer may be returned by a mobile robot 1030 from the storage structure 1002 back to either side A 1016 or side B 1020 of the workstation 1015, and the operator 1012 may then move the products associated with the pending orders being fulfilled from the order tote 1032 directly into the containers 1060 that are preloaded into one or more shopping carts 1070 located at the workstation 1015. As mentioned above, the containers 1060 located in the shopping carts 1070 may be automatically pre-loaded into the shopping carts 1070 via a container dispenser 1080, such as disclosed in U.S. patent application Ser. No. 17/884,345, filed Aug. 9, 2022 and entitled “Container to Tote Dispense Integrated With Automated Storage and Retrieval System,” incorporated by reference herein in its entirety. Then, the shopping carts 1070 with the container(s) 1060 with the products associated with the order being picked up by the customer may be moved by the operator 1012 or another worker (or guided via a remote control) to an order pickup area, where a worker may remove the container(s) 1060 from the shopping cart(s) 1070 and hand over the customer-ordered products to the customer.

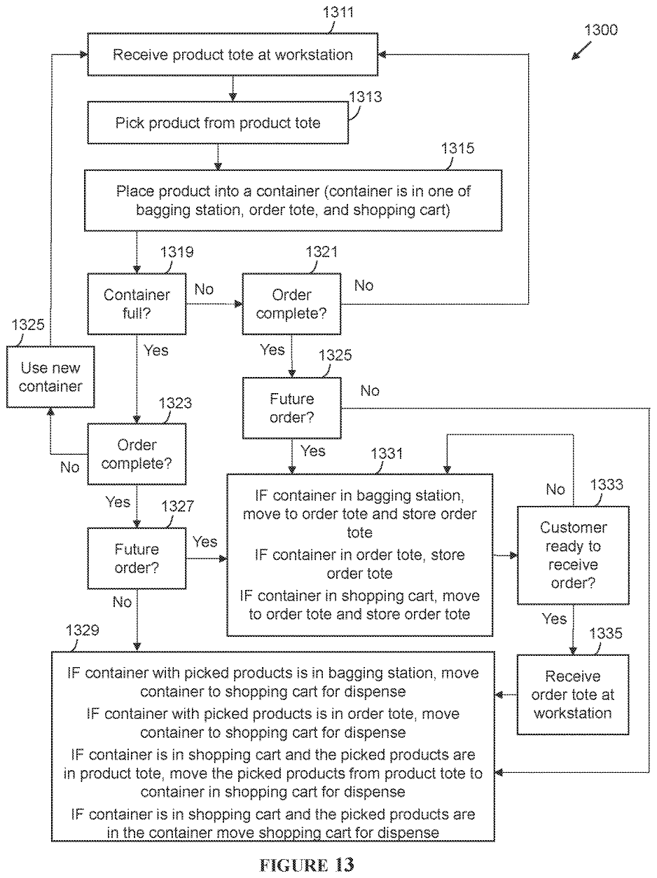

FIG. 13 is a process flow diagram for an exemplary process 1300 according to some embodiments whereby eaches are sequentially picked from totes (e.g., totes 932) located at picking/placement area A (e.g., area A 916) and/or picking placement area B (e.g., area B 920) of the workstation (e.g., workstation 915), placed in containers (e.g., containers 960), and transferred to shopping carts (e.g., shopping carts 970) for transport to a product pickup area. For exemplary purposes, this flow chart will be described with reference to the components of FIGS. 9 and 10, although it is understood that the process of this flowchart can also apply to the components of FIGS. 11 and 12.

The sequence begins at step 1311 where a product tote 932 is received (e.g., presented by a mobile robot 930) at side A 916 and/or side B 920 of the workstation 915. At step 1313, the operator 912 picks a product from a product tote 932 at side A 916 or side B 920 of the workstation 915. At step 1315, the operator 912 places the product picked from a product tote 932 into a container 960 located in one of: the bagging location 924 of the workstation 915, an order tote 932 positioned at side A 916 and/or side B 920 of the workstation 915, or a shopping cart 970 located at or near the workstation 915.

If the container 960 is not full (step 1319) and if the order is not complete (step 1321), then the process 1300 cycles back to step 1311, where a new product tote 932 is received at the workstation 915 for the operator 912 to pick another product from the newly-received product tote 932 in an attempt to completely fulfill the current order. On the other hand, if the container 960 is full (step 1319) but the order is not complete (step 1323), then the operator 912 uses a new container 960 (step 1325) and the process 1300 cycles back to step 1311, where the operator 912 continues the picking of another product from the product tote 932 in an attempt to fulfill the current order.

If the order is complete (step 1321 or step 1323) and the order is not a future order (step 1325 or step 1327), then the process 1300 proceeds to step 1329, where the operator 912 may perform one or more of the following actions: (1) if the container 960 with the picked products is in the bagging station 924 of the workstation 915, the operator 912 would move the container 960 to the shopping cart 970 so the shopping cart can be moved to dispense the order to the customer at an order pickup area; (2) if the container 960 with the picked products is in an order tote 932 at either side A 916 or side B 920 of the workstation 915, the operator 912 would move the container 960 from the order tote 932 into the shopping cart 970 so the shopping cart can be moved to dispense the order to the customer at an order pickup area; (3) if the container 960 is in the shopping cart 970, and the picked products are located in an order tote 932, the operator moves the picked products from the order tote 932 into the container 960 located in the shopping cart 970 so the shopping cart can be moved to dispense the order to the customer at an order pickup area; and (4) if the container 960 is in the shopping cart 970 and the picked products are located in the container 960, the shopping cart 970 is ready to be moved to dispense the order to the customer at an order pickup area.

If the order is complete (step 1321 or step 1323) and the order is a future order (step 1325 or step 1327), then the process 1300 proceeds to step 1331, where the operator 912 may perform one or more of the following actions: (1) if the container 960 with the picked products is in the bagging station 924 of the workstation 915, the operator 912 would move the container 960 to an order tote 932, which is then moved by a mobile robot to be stored in the product storage structure 902 until the order is ready to be dispensed; (2) if the container 960 with the picked products is in an order tote 932, the operator 912 would instruct the system such that the order tote 932 will be moved by a mobile robot for storage in the product storage structure 902 until the order is ready to be dispensed; and (3) if the container 960 is in the shopping cart 970, the operator will move the container into an order tote 932 that will be stored in the product storage structure 902 until the order is ready to be dispensed.

In the exemplary method 1300, when the order tote 932 that either contains the picked products directly or the containers 960 that contain the picked products is stored in the product storage structure 902 at step 1331, while the customer is not ready to receive the order at step 1333, the order tote 932 continues to be stored in the product storage structure 902. On the other hand, if the customer is ready to receive the order at step 1333, the order tote 932 is moved (e.g., by a mobile robot 930) from the product storage structure 902 to side A 916 or side B 920 of the workstation 915 in step 1335, after which the process 1300 proceeds to step 1329, which was described above.

As noted above, the process of FIG. 13 also applies to the components of FIGS. 11 and 12, except that these embodiments lacking a bagging station 924. Thus, the bagging station of steps 1315, 1329 and 1331 is not included. Further, the process of FIG. 13 may apply to embodiments described herein, however, reference to shopping cart may simply be to a shopping cart not shown in other embodiments or to an order tote or other product dispense carrier, roller, cart, trolley, etc.

In accordance with an example embodiment, a non-transitory program storage device readable by a machine may be provided, such as memory, for example, tangibly embodying a program of instructions executable by the machine for performing operations, the operations comprising: calculating routing of mobile robots and totes to stage and sequence mobile robots and totes as described in connection with the various embodiments disclosed herein.

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Several embodiments of fulfillment systems and methods are described herewith. In some embodiments, an order fulfillment system is provided for fulfilling orders for goods, the system including: a storage structure configured to store totes; mobile robots configured to transport the totes; and a workstation. The workstation includes: a first station configured to receive product totes of the totes, the product totes having the goods for fulfilling the orders, a second station configured to receive order totes of the totes, the order totes having the goods of fulfilled orders, and a third station configured to receive containers, the containers configured to receive the goods from one or more of the product totes. And the container of the containers is configured to be transferred from the third station to an order tote of the order totes at the second station when it is determined that the container has reached a predetermined capacity.

In some embodiments, the third station may be configured to store multiple containers. In some embodiments, the workstation may be configured with multiple levels configured to transport multiple mobile robots with the product totes to the workstation. In some embodiments, the workstation may be configured with multiple levels configure to transport multiple mobile robots with order totes away from the workstation. In some embodiments, the third station may be configured to hold multiple containers stacked in one another in a nested configuration. In some embodiments, the third station may be configured to index vertically and may be configured to position an uppermost container of the multiple containers at a vertical height that is ergonomic for an operator to place goods into the uppermost container. In some embodiments, the system may include a vision verification system configured to sequentially guide pick operations of the goods from the product totes. The vision verification system may be further configured to sequentially guide place operations the goods into at least one of the containers at the third station and the order totes at the second station. The system may further include a controller having a processor configured to control the operation of the vision verification system. And in some embodiments, the system may include a container dispenser configured to load the containers into at least one of the third station and the order totes located at the second station.

In some embodiments, an order fulfillment system is provided for fulfilling orders for goods. The system includes: a storage structure configured to store totes; mobile robots configured to transport the totes; and a workstation. The workstation includes: a first station configured to receive product totes of the totes, the product totes having the goods for fulfilling the orders, a second station configured to receive order totes of the totes, the order totes having the goods of fulfilled orders, and a third station configured to receive containers, the containers configured to receive the goods from one or more of the product totes. The container of the containers is configured to be transferred from the third station to at least one of: an order tote of the order totes at the second station when it is determined that the container has reached a predetermined capacity; and one or more shopping carts located at the workstation when it is determined that the container has reached the predetermined capacity.

In some embodiments, the system may include a container dispenser configured to load the containers into at least one of the third station, the order totes located at the second station, and the at least one shopping cart located at the workstation. And in some embodiments, the one or more shopping carts may one or more of the containers configured to receive the goods directly from the product totes or the order totes.

In some embodiments, a method of operating an order fulfillment system for fulfilling orders for goods is provided. The method includes the steps of: (a) transporting product totes to a first station at a workstation; (b) transporting order totes to a second station at the workstation; (c) picking goods from the product totes into one or more containers at a third station; (d) determining when a container of the one or more containers is at capacity; and (e) transporting the container determined to be at capacity in said step (d) into an order tote at the second station.

In some embodiments, step (d) may further include determining when the container is filled to capacity. Step (d) may include determining when the container has reached a predetermined weight capacity. In some embodiments, the method may further include transporting product totes to the second station and buffering an order tote at a fourth station at the workstation until the order tote is needed to receive the container in step (e). In some embodiments, the method may further include replenishing a new container to the third station after step (e) of transporting the container determined to be at capacity in said step (d) into the at least one of an order tote at the second station and the at least one shopping cart located at the workstation. In some embodiments, the method may further comprise a step of automatically opening a container at the third station to ensure the container is ready to receive the goods. In some embodiments, the method may further include loading, via a container dispenser, the containers into at least one of the third station and the order totes located at the second station.

Further, in some embodiments, a method of operating an order fulfillment system is provided for fulfilling orders for goods. The method includes: transporting product totes to a first station at a workstation; transporting order totes to a second station at the workstation; picking goods from the product totes into one or more containers at a third station; determining when a container of the one or more containers is at capacity; and when the container is determined to be at the capacity, transporting the container into at least one of: an order tote at the second station; and at least one shopping cart located at the workstation.

In some embodiments, the method may further include loading, via a container dispenser, the containers into at least one of the third station, the order totes located at the second station, and the at least one shopping cart located at the workstation. And in some embodiments, the method may further include storing, in the at least one stopping cart, at least one of the containers configured to receive the goods directly from the product totes or the order totes.

Additionally, in some embodiments, another order fulfillment system is provided for fulfilling orders for goods. The system includes: a storage structure configured to store totes; mobile robots configured to transport the totes; and a workstation. The workstation includes: a first station configured to receive product totes of the totes, the product totes having the goods for fulfilling the orders, a second station configured to receive order totes of the totes, the order totes having the goods of fulfilled orders, and at least one shopping cart configured to receive and store containers, the containers configured to receive the goods from one or more of the product totes or one or more of the order totes.

The foregoing detailed description has been presented for purposes of illustration and description. It is not intended to be exhaustive or to limit the description to the precise form disclosed. Many modifications and variations are possible in light of the above teaching. The described embodiments were chosen in order to best explain the principles of the claimed system and its practical application to thereby enable others skilled in the art to best utilize the claimed system in various embodiments and with various modifications as are suited to the particular use contemplated. It is intended that the scope of the method be defined by the claims appended hereto.

What is claimed is:

1. An order fulfillment system for fulfilling orders for goods, the system comprising:
a storage structure configured to store totes;
mobile robots configured to transport the totes; and
a workstation, comprising:
a first station configured to receive product totes of the totes, the product totes having the goods for fulfilling the orders,
a second station configured to receive order totes of the totes, the order totes having the goods of fulfilled orders, and
a third station configured to receive containers, the containers configured to receive the goods from one or more of the product totes;
wherein a container of the containers is configured to be transferred from the third station to an order tote of the order totes at the second station when it is determined that the container has reached a predetermined capacity.

2. The order fulfillment system of claim 1, wherein the third station is configured to store multiple containers.

3. The order fulfillment system of claim 1, wherein the workstation is configured with multiple levels configured to transport multiple mobile robots with the product totes to the workstation.

4. The order fulfillment system of claim 1, wherein the workstation is configured with multiple levels configure to transport multiple mobile robots with order totes away from the workstation.

5. The order fulfillment system of claim 1, wherein the third station is configured to hold multiple containers stacked in one another in a nested configuration.

6. The order fulfillment system of claim 5, wherein the third station is configured to index vertically, and is configured to position an uppermost container of the multiple containers at a vertical height that is ergonomic for an operator to place goods into the uppermost container.

7. The order fulfillment system of claim 1, further comprising a vision verification system configured to sequentially guide pick operations of the goods from the product totes.

8. The order fulfillment system of claim 7, wherein the vision verification system is further configured to sequentially guide place operations the goods into at least one of the containers at the third station and the order totes at the second station.

9. The order fulfillment system of claim 7, further comprising a controller having a processor configured to control the operation of the vision verification system.

10. The order fulfillment system of claim 1, further comprising a container dispenser configured to load the containers into at least one of the third station and the order totes located at the second station.

11. An order fulfillment system for fulfilling orders for goods, the system comprising:
a storage structure configured to store totes;
mobile robots configured to transport the totes; and
a workstation, comprising:
a first station configured to receive product totes of the totes, the product totes having the goods for fulfilling the orders,
a second station configured to receive order totes of the totes, the order totes having the goods of fulfilled orders, and
a third station configured to receive containers, the containers configured to receive the goods from one or more of the product totes;
wherein a container of the containers is configured to be transferred from the third station to at least one of:
an order tote of the order totes at the second station when it is determined that the container has reached a predetermined capacity; and
at least one shopping cart located at the workstation when it is determined that the container has reached the predetermined capacity.

12. The order fulfillment system of claim 11, further comprising a container dispenser configured to load the containers into at least one of the third station, the order totes located at the second station, and the at least one shopping cart located at the workstation.

13. The order fulfillment system of claim 11, wherein the at least one shopping cart stores at least one of the containers configured to receive the goods directly from the product totes or the order totes.

14. A method of operating an order fulfillment system for fulfilling orders for goods, the method comprising:
(a) transporting product totes to a first station at a workstation;
(b) transporting order totes to a second station at the workstation;
(c) picking goods from the product totes into one or more containers at a third station;
(d) determining when a container of the one or more containers is at capacity; and
(e) transporting the container determined to be at capacity in said step (d) into an order tote at the second station.

15. The method of claim 14, wherein said step (d) comprises the step of determining when the container is filled to capacity.

16. The method of claim 14, wherein said step (d) comprises the step of determining when the container has reached a predetermined weight capacity.

17. The method of claim 14, further comprising a step of transporting product totes to the second station and buffering an order tote at a fourth station at the workstation until the order tote is needed to receive the container in said step (e).

18. The method of claim 14, further comprising a step of replenishing a new container to the third station after said step (e) of transporting the container determined to be at capacity in said step (d) into the order tote at the second station.

19. The method of claim 14, further comprising the step of automatically opening a container at the third station to ensure the container is ready to receive the goods.

20. The method of claim 14, further comprising loading, via a container dispenser, the containers into at least one of the third station and the order totes located at the second station.

21. A method of operating an order fulfillment system for fulfilling orders for goods, the method comprising:
transporting product totes to a first station at a workstation;
transporting order totes to a second station at the workstation;
picking goods from the product totes into one or more containers at a third station;
determining when a container of the one or more containers is at capacity; and
when the container is determined to be at the capacity, transporting the container into at least one of:
an order tote at the second station, and
at least one shopping cart located at the workstation.

22. The method of claim 21, further comprising loading, via a container dispenser, the containers into at least one of the third station, the order totes located at the second station, and the at least one shopping cart located at the workstation.

23. The method of claim 21, further comprising storing, in the at least one stopping cart, at least one of the containers configured to receive the goods directly from the product totes or the order totes.

24. An order fulfillment system for fulfilling orders for goods, the system comprising:
a storage structure configured to store totes;
mobile robots configured to transport the totes; and
a workstation, comprising:
a first station configured to receive product totes of the totes, the product totes having the goods for fulfilling the orders,
a second station configured to receive order totes of the totes, the order totes having the goods of fulfilled orders, and
at least one shopping cart configured to receive and store containers, the containers configured to receive the goods from one or more of the product totes or one or more of the order totes.
